(19) United States
(12) Patent Application Publication
(10) Pub. No.: US 2024/0279910 A1
(43) Pub. Date: Aug. 22, 2024

(54) WORK SITE MONITORING SYSTEM

(71) Applicant: KOBELCO CONSTRUCTION MACHINERY CO., LTD., Hiroshima-shi (JP)

(72) Inventors: Yukihiro HOSO, Hiroshima (JP); Sho FUJIWARA, Hiroshima (JP); Shingun KYU, Hiroshima (JP); Yoshiki MUNEMASA, Hiroshima (JP)

(73) Assignee: KOBELCO CONSTRUCTION MACHINERY CO., LTD., Hiroshima-shi (JP)

(21) Appl. No.: 18/569,669

(22) PCT Filed: Mar. 11, 2022
(86) PCT No.: PCT/JP2022/011024

§ 371 Date: Dec. 13, 2023

(30) Foreign Application Priority Data
Jul. 5, 2021 (JP) 2021-111237

(51) Int. Cl. E02F 9/26; E02F 9/20; E02F 9/24

(52) U.S. Cl. CPC E02F 9/262; E02F 9/205; E02F 9/2054; E02F 9/24; E02F 9/265

(57) ABSTRACT

Provided is a worksite monitoring system that achieves suppression of a decrease in the work efficiency of a working machine. The worksite monitoring system includes: a camera that captures an image of a worksite; an object detection part that detects, on the basis of the image captured by the camera, a working machine in the worksite; a position acquisition part that acquires a position of the working machine detected by the object detection part; a type determination part that determines a type of the working machine detected by the object detection part; a working area setting part that sets a working area associated with the type determined by the type determination part for the working machine detected by the object detection part; and an unsafety state detection part that detects an unsafety state on the basis of the position of the working machine acquired by the position acquisition part and the working area set by the working area setting part.

### TECHNICAL FIELD

The present invention relates to a worksite monitoring system that monitors a person and a working machine in a worksite.

### BACKGROUND ART

Patent Literature 1 discloses a safety management system that prevents target objects, such as working machines, from coming into contact with each other in a worksite. The safety management system includes: a photographing part that photographs an entirety of the worksite to acquire an outline of a working machine and an outline of an operator in a working area, and sets areas respectively for the target objects; and a notification part that notifies that the areas of the target objects come into contact with each other or displace from the working area.

### CITATION LIST

### Patent Literature

Patent Literature 1: Japanese Unexamined Patent Publication No. 2012-203677

An operator driving working machine, a remotely driving working machine, and an autonomous driving working machine may work together in a worksite. The operator driving working machine, the remotely driving working machine, and the autonomous driving working machine have their respective work contents different from one another. Under the circumstances, setting of a uniform working area for each of these types of the working machines is likely to cause an unsafety state, such as contact between working areas and displacement from the working areas. In this case, frequent notification or frequent stopping of the working machine corresponding to the unsafety state may occur, resulting in decreasing the work efficiency of the working machine.

### SUMMARY OF INVENTION

An object of the present invention is to provide a worksite monitoring system that achieves suppression of a decrease in work efficiency of a working machine.

The present invention provides a worksite monitoring system. The worksite monitoring system includes: an image capturing part that captures an image of a worksite; an object detection part that is configured to detect, on the basis of the image captured by the image capturing part, a working machine in the worksite; a position acquisition part that acquires a position of the working machine detected by the object detection part; a type determination part that determines a type of the working machine detected by the object detection part; a working area setting part that sets a working area associated with the type determined by the type determination part for the working machine detected by the object detection part; and an unsafety state detection part that detects an unsafety state on the basis of the position of the working machine acquired by the position acquisition part and the working area set by the working area setting part.

### BRIEF DESCRIPTION OF DRAWINGS

FIG. 1 is a configurational diagram of a worksite monitoring system according to an embodiment of the present invention.

FIG. 2 is a side view of a working machine in the embodiment of the present invention.

FIG. 3 is a diagram showing a circuit configuration of each of the worksite monitoring system and the working machine in the embodiment of the present invention.

FIG. 4 is an illustration of a state where a person is in a working area for the working machine in the embodiment of the present invention.

FIG. 5 is an illustration of a state where a bucket extends beyond the working area for the working machine in the embodiment of the present invention.

FIG. 6 is a flowchart of a monitoring control process in the embodiment of the present invention.

### DESCRIPTION OF EMBODIMENTS

Hereinafter, a preferable embodiment of the present invention will be described with reference to the accompanying drawings.

### Configuration of a Worksite Monitoring System

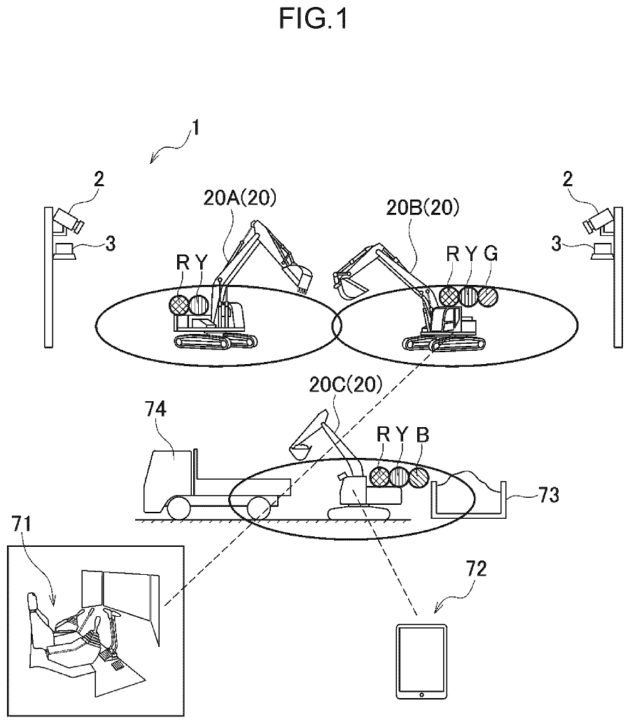

A worksite monitoring system according to an embodiment of the present invention is configured to monitor a person and a working machine in a worksite. FIG. 1 is a configurational diagram of a worksite monitoring system 1 according to the embodiment. As shown in FIG. 1, the worksite monitoring system 1 includes a plurality of cameras 2 and a plurality of LiDAR sensors 3.

The cameras (image capturing parts) 2 are provided at different positions in the worksite to respectively capture images of the worksite. An operator driving working machine 20A, a remotely driving working machine 20B, and an autonomous driving working machine 20C work together in the worksite. The working machines 20A to 20C are collectively called a “working machine 20”.

The remotely driving working machine 20B is wirelessly and remotely operated or manipulated from a cockpit 71 located away from the working machine 20B. Specifically, the “remote driving or manipulation” in the embodiment means performance by the working machine 20B on a predetermined work in response to a manipulation by an operator, who is not on the working machine 20B, from a remote location to the working machine 20B. The autonomous driving working machine 20C is taught by an operator through a manipulation to a tablet 72 before autonomous driving. Examples of a work content defined with teaching information, i.e., working plan information about the autonomous driving, acquired through the teaching include scooping soil and sand from a soil and sand pit 73 and transferring the soil and sand to a load bed of the dump truck 74. Another way may be adopted in place of the teaching to input the working plan information, e.g., a program, about the autonomous driving into a controller of the autonomous driving working machine 20C. Specifically, the “autonomous driving” in the embodiment means autonomous execution of a predetermined work by the working machine 20C in response to a preset command or instruction without a manipulation by an operator.

The LiDAR (Light Detection and Ranging or Laser Imaging Detection and Ranging) sensors 3 are provided at the different positions in the worksite. Each of the LiDAR sensors 3 acquires point cloud data indicating a distance from the position of the LiDAR sensor 3 to an object, i.e., a working machine 20 or a person, in the worksite. A stereo camera or a TOF (Time Of Flight) sensor may be adopted in place of the LiDAR sensor 3. In the embodiment, one camera 2 and one LiDAR sensor 3 are arranged adjacent to each other in a set.

### Configuration of the Working Machine

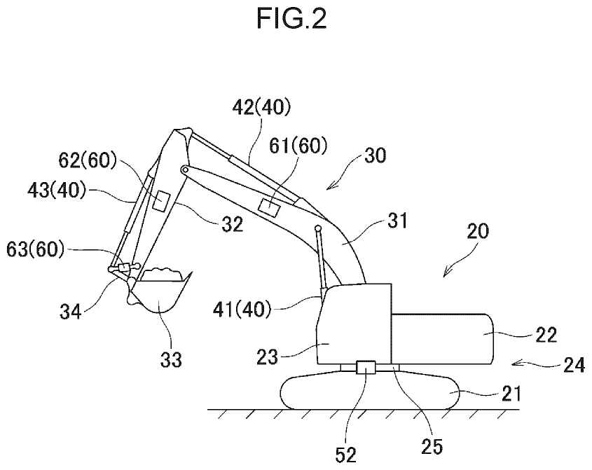

FIG. 2 is a side view of the working machine 20 in the embodiment. As shown in FIG. 2, the working machine 20 performs a work with an attachment 30, and serves as, for example, a hydraulic excavator. The working machine 20 includes: a machine main body 24 having a lower traveling body 21 and an upper slewing body 22; the attachment 30; and cylinders 40.

The lower traveling body 21 causes the working machine 20 to travel, and includes, for example, a crawler. The upper slewing body 22 is slewably attached onto an upper portion of the lower traveling body 21 via a slewing device 25. The upper slewing body 22 has a front portion provided with a cab (operation compartment) 23.

The attachment 30 is attached to the upper slewing body 22 rotatably in an up-down direction. The attachment 30 includes a boom 31, an arm 32, and a bucket 33. The boom 31 is attached to the upper slewing body 22 rotatably (tiltably) in the up-down direction. The arm 32 is attached to the boom 31 rotatably in the up-down direction. The bucket 33 is attached to the arm 32 rotatably in the front-rear direction. The bucket 33 performs works including excavation, leveling, and scooping of soil and sand (transfer target). The transfer target to be held by the bucket 33 is not limited to the soil and sand, and may be a stone, waste including industrial waste, or other target.

Each cylinder 40 enables the attachment 30 to rotate under a hydraulic pressure. Each cylinder 40 is a hydraulic extendable and contractable cylinder. The cylinders 40 include a boom cylinder 41, an arm cylinder 42, and a bucket cylinder 43.

The boom cylinder 41 rotates the boom 31 with respect to the upper slewing body 22. The boom cylinder 41 has a proximal end rotatably attached to the upper slewing body 22. The boom cylinder 41 has a distal end rotatably attached to the boom 31.

The arm cylinder 42 rotates the boom 31 with respect to the arm 32. The arm cylinder 42 has a proximal end rotatably attached to the boom 31. The arm cylinder 42 has a distal end rotatably attached to the arm 32.

The bucket cylinder 43 rotates the bucket 33 with respect to the arm 32. The bucket cylinder 43 has a proximal end rotatably attached to the arm 32. The bucket cylinder 43 has a distal end rotatably attached to a link member 34 rotatably attached to the bucket 33.

The working machine 20 further has an angle sensor 52 and a tilt angle sensor 60.

The angle sensor 52 detects a slewing angle of the upper slewing body 22 to the lower traveling body 21. The angle sensor 52 includes, for example, an encoder, a resolver, or a gyro sensor. In the embodiment, the upper slewing body 22 has a slewing angle of 0° when a frontward direction of the upper slewing body 22 and a frontward direction of the lower traveling body 21 agree with each other.

The tilt angle sensor 60 detects a posture of the attachment 30. The tilt angle sensor 60 includes a boom tilt angle sensor 61, an arm tilt angle sensor 62, and a bucket tilt angle sensor 63. The boom tilt angle sensor 61 is attached to the boom 31 to detect a posture of the boom 31. The boom tilt angle sensor 61 acquires a tilt angle of the boom 31 to a horizontal line, and is, for example, a tilt (acceleration) sensor. The boom tilt angle sensor 61 may be a rotation angle sensor for detecting a rotation angle of a boom foot pin (boom proximal end) or a stroke sensor for detecting a stroke amount of the boom cylinder 41.

The arm tilt angle sensor 62 is attached to the arm 32 to detect a posture of the arm 32. The arm tilt angle sensor 62 acquires a tilt angle of the arm 32 to the horizontal line, and is, for example, a tilt (acceleration) sensor. The arm tilt angle sensor 62 may be a rotation angle sensor for detecting a rotation angle of an arm connection pin (arm proximal end) or a stroke sensor for detecting a stroke amount of the arm cylinder 42.

The bucket tilt angle sensor 63 is attached to the link member 34 to detect a posture of the bucket 33. The bucket tilt angle sensor 63 acquires a tilt angle of the bucket 33 to the horizontal line, and is, for example, a tilt (acceleration) sensor. The bucket tilt angle sensor 63 may be a rotation angle sensor for detecting a rotation angle of a bucket connection pin (bucket proximal end) or a stroke sensor for detecting a stroke amount of the bucket cylinder 43.

### Circuit Configuration of Each of the Worksite Monitoring System and the Working Machine

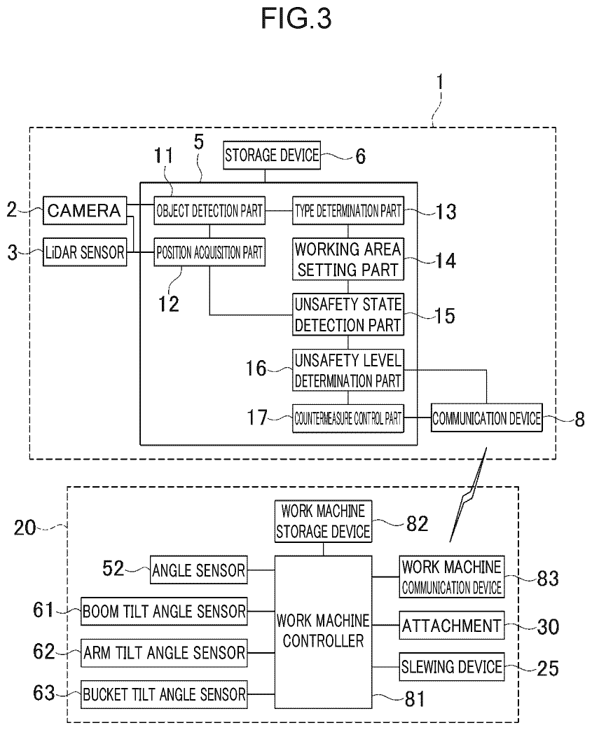

FIG. 3 is a diagram showing a circuit configuration of each of the worksite monitoring system 1 and the working machine 20. As shown in FIG. 3, the working machine 20 has a working machine controller 81, a working machine storage device 82, and a working machine communication device 83.

The working machine controller 81 receives an input of information about a slewing angle or posture of the upper slewing body 22 to the lower traveling body 21, the slewing angle or posture having been detected by the angle sensor 52. The working machine controller 81 further receives an input of information about a posture of the boom 31 detected by the boom tilt angle sensor 61. Besides, the working machine controller 81 receives an input of information about a posture of the arm 32 detected by the arm tilt angle sensor 62. Moreover, the working machine controller 81 receives an input of information about a posture of the bucket 33 detected by the bucket tilt angle sensor 63.

For the autonomous driving working machine 20C, the working machine storage device 82 stores teaching information. For the autonomous driving working machine 20C, the working machine controller 81 causes the attachment 30 and the slewing device 25 to operate on the basis of the teaching information stored in the working machine storage device 82.

The working machine communication device 83 is communicable with a communication device 8 included in the worksite monitoring system 1 to be described below.

The worksite monitoring system 1 includes a controller 5, a storage device 6, and the communication device 8. The communication device 8 is communicable with the working machine communication device 83 of the working machine 20.

The controller 5 has an object detection part 11, a position acquisition part 12, a type determination part 13, a working area setting part 14, and an unsafety state detection part 15.

The object detection part 11 is configured to detect, on the basis of an image captured by the camera 2, a working machine 20 in a worksite. The object detection part 11 is further configured to detect, on the basis of the image captured by the camera 2, a person in the worksite. A deep learning technique or another way may be adopted to detect the working machine 20 and the person.

The position acquisition part 12 acquires a position of the working machine 20 detected by the object detection part 11. The position acquisition part 12 further acquires a position of the person detected by the object detection part 11. Specifically, the position acquisition part 12 uses a position (coordinate) of each LiDAR sensor 3 in a global coordinate system and a distance between the LiDAR sensor 3 to each point of point cloud data to calculate a position (three-dimensional coordinate) of each point of the point cloud data in the global coordinate system. Next, the position acquisition part 12 performs perspective projection and transformation onto the three-dimensional coordinate of each point of the point cloud data to acquire a two-dimensional coordinate of the point of the point cloud data. The position acquisition part 12 then superimposes the two-dimensional coordinate of the point of the point cloud data on a two-dimensional image captured by the camera 2. The position acquisition part 12 acquires a three-dimensional position of each of the working machine 20 and the person detected by the object detection part 11 from a three-dimensional coordinate of each of points of the point cloud data where the working machine 20 and the person detected by the object detection part 11 are respectively located in the superimposition.

Here, a positioning sensor like a GNSS sensor, or a distance measurement sensor like a total station acquires the position of each of the camera 2 and the LiDAR sensor 3 in the global coordinate system.

The type determination part 13 determines a type of the working machine 20 detected by the object detection part 11. As illustrated in FIG. 1, a color lamp included in a working machine 20 is used to determine a type of the working machine 20. The operator driving working machine 20A includes a red lamp R and a yellow lamp Y attached thereto. The remotely driving working machine 20B includes a red lamp R, a yellow lamp Y, and a green lamp G attached thereto. The autonomous driving working machine 20C includes a red lamp R, a yellow lamp Y, and a blue lamp B attached thereto. The type determination part 13 determines each type of the working machine 20 from the different colors of the lamps. In the embodiment, types of working machines 20 include at least two working machines among the operator manipulating working machine 20A, the remotely driving working machine 20B, and the autonomous driving working machine 20C.

Referring back to FIG. 3, the working area setting part 14 sets a working area for each of working machines 20 detected by the object detection part 11. In this regard, the working area setting part 14 sets a working area associated with the type determined by the type determination part 13 for the working machine 20.

For instance, a working area for the operator driving working machine 20A is set to be larger than a working area for the remotely driving working machine 20B and a working area for the autonomous driving working machine 20C in consideration of manipulation flexibility for an operator. The working area for the autonomous driving working machine 20C is set to be smaller than the working area for the remotely driving working machine 20B in consideration of a work content of the working machine 20C defined on the basis of teaching.

The unsafety state detection part 15 detects an unsafety state on the basis of the position of the working machine 20 acquired by the position acquisition part 12 and the working area set by the working area setting part 14. The unsafety state detection part 15 further detects an unsafety state on the basis of the position of the person acquired by the position acquisition part 12 and the working area set by the working area setting part 14.

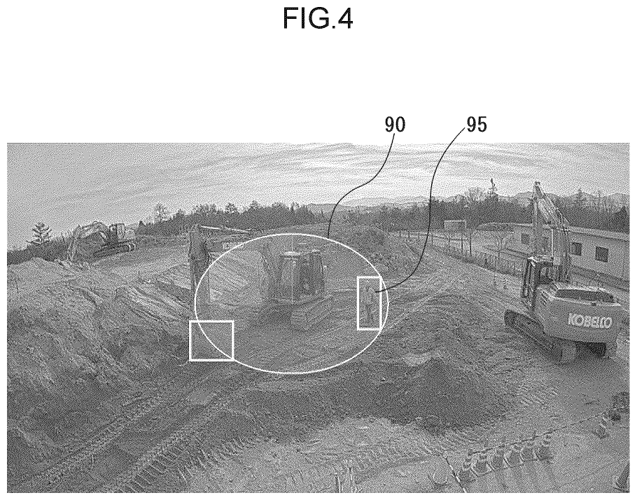

Here, the unsafety state includes a state where another working machine 20 is in a working area for a certain working machine 20. The unsafety state further includes a state where a person is in the working area for the working machine 20. FIG. 4 is an illustration of a state where a person is in the working area. In FIG. 4, a person 95 is in a working area 90 for a working machine 20.

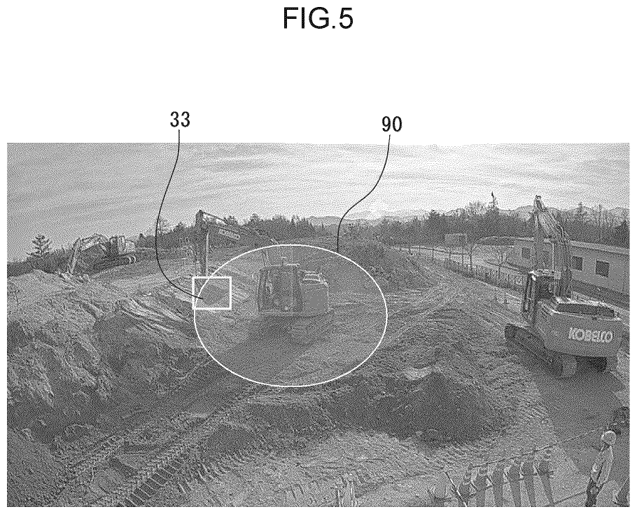

The unsafety state includes a state where a machine body of the working machine 20 is beyond the working area therefor. FIG. 5 is an illustration of a state where the machine body of the working machine 20 is beyond the working area therefor. In FIG. 5, the bucket 33 extends beyond the working area 90 for the working machine 20.

Referring back to FIG. 3, the controller 5 has an unsafety level determination part 16 and a countermeasure control part 17. The unsafety level determination part 16 determines an unsafety level on the basis of the unsafety state detected by the unsafety state detection part 15. In the embodiment, the unsafety level is classified into three stages of “high”, “medium”, and “low” as shown in Table 1 below. A higher unsafety level means a more serious human damage.

TABLE 1

| | | | Operator | Autonomous driving | | Remotely |
|---|---|---|---|---|---|---|
| | | | driving | working machine | | driving |
| | | | working | | Autonomous | working |
| | | Person | machine | Teaching | driving | machine |
| Operator driving working machine | | Medium | Medium | Medium | High | High |
| Autonomous | Teaching | Medium | Medium | Medium | High | High |
| driving | Autonomous | High | High | High | Low | Low |
| working | driving | | | | | |
| machine | | | | | | |

| | | | | | |
|---|---|---|---|---|---|
| Remotely driving machine | High | High | High | Low | Low |

For instance, the unsafety level is determined to be “low” for an incident which is irrelevant to an occurrence of a human damage, e.g., a collision between the remotely driving working machine 20B and the autonomous driving working machine 20C. The unsafety level is determined to be “medium” for an incident which is relevant to an occurrence of a human damage but dependable on judgement by a person and an operator or by operators each other to avoid the incident, e.g., a collision between the operator driving working machine 20A and the person, and a collision between the operator driving working machine 20A and the working machine 20C being taught. The unsafety level is determined to be “high” for an incident which is relevant to an occurrence of a human damage and is unavoidable only with judgment by a person or an operator, e.g., a collision between the autonomous driving working machine 20C and the person, and a collision between the remotely driving working machine 20B and the operator driving working machine 20A.

In this respect, the unsafety level may be set in accordance with a work content of a working machine 20. For instance, a working area is relatively large for the work content of slewing of an attachment 30, and thus, the unsafety level is desirably set to be “high”. A working area is relatively small for the work content of excavation, and thus, the unsafety level is preferably set to be “low”.

The countermeasure control part (control part) 17 performs at least one of warning and stopping of the working machine 20 in accordance with the unsafety level determined by the unsafety level determination part 16. In the embodiment, the warning is emitted to outside at the “low” unsafety level. The warning is emitted to the outside and the work of the working machine 20 is stopped without stopping an engine thereof at the “medium” unsafety level. The engine of the working machine 20 is stopped at the “high” unsafety level.

The warning to the outside is emitted from a warning device. The warning device includes a display or a speaker provided in the cockpit 71 or the working machine 20. An operator manipulating in the cockpit 71 may change an operation of the remotely driving working machine 20B in response to warning to avoid contact between working machines 20. An operator on the operator driving working machine 20A may change an operation of the working machine 20A in response to warning to avoid contact between working machines 20.

The communication device 8 transmits an instruction of stopping a work to an associated working machine 20 to stop the work of the working machine 20. The working machine controller 81 having received the instruction of stopping the work temporarily stops an operation of each of the attachment 30 and the slewing device 25. This may avoid a collision between a working machine 20 and a person, and a collision between working machines 20.

The communication device 8 transmits an instruction of stopping an engine of an associated working machine 20 to stop the engine of the working machine 20. The working machine controller 81 having received the instruction of stopping the engine stops the engine (which is not shown). This may avoid a collision between a working machine 20 and a person, and a collision between working machines 20.

Here, for a plurality of types of working machines 20, a working area associated with each of the types of the working machines 20 is set as stated above. Accordingly, the setting enables more accurate detection of an unsafety status than a setting of a uniform working area for each of the types of the working machines 20. This may keep a state detected as an unsafety state in the setting of the uniform working area for each of the types of the working machines 20 from being detected as such an unsafety state. This consequently eliminates unnecessary execution of a countermeasure, such as notification or stopping of a working machine 20, and thus achieves suppression of a decrease in the work efficiency of the working machine 20.

As shown in FIG. 4, when a person or another working machine 20 enters a specific working area, a countermeasure, such as notification or stopping of the working machine 20, is executed to avoid a collision between a person and the working machine 20, and a collision between working machines 20 in advance. As shown in FIG. 5, when a machine body of a working machine 20 is beyond a working area therefor, a countermeasure, such as notification or stopping of the working machine 20, is applicable to avoid a collision between a person and the working machine 20, and a collision with another working machine 20 in advance.

Meanwhile, the working area setting part 14 shown in FIG. 3 sets a working area for the autonomous driving working machine 20C on the basis of teaching information. A work content of the autonomous driving working machine 20C is defined with the teaching information. A setting of the working area based on the teaching information enables more accurate detection of an unsafety state.

The working area setting part 14 sets the working area for the autonomous driving working machine 20C further on the basis of determination as to whether an operator is on the working machine 20C. The determination as to whether an operator is on the autonomous driving working machine 20C is made from an image captured by the camera or determination part 2. In this regard, a camera may be set in a cab 23 of the autonomous driving working machine 20C to determine whether the operator is in the cab 23. Alternatively, a thermo-sensor may be provided in the cab 23 to determine whether the operator is in the cab 23. Further alternatively, a sensor may be provided to an operating seat in the cab 23 to determine whether the operator is sitting on the operating seat.

For instance, in a case where the operator is on the autonomous driving working machine 20C for teaching, a working area is set to be larger than the working area in a case where the operator is not on the autonomous driving working machine 20C in consideration of the manipulation flexibility for the operator. The setting enables more accurate detection of an unsafety state than a setting of a uniform working area that is made regardless of existence or absence of an operator on the machine.

The storage device 6 stores a work content of each of the operator driving working machine 20A and the remotely driving working machine 20B. The working area setting part 14 sets, on the basis of the work content stored in the storage device 6, a working area for each of the operator driving working machine 20A and the remotely driving working machine 20B.

The operator driving working machine 20A and the remotely driving working machine 20B often repeat their respective works. The storage device 6 stores relevant work contents of the works for use in setting a working area, and such setting leads to narrowing down the working area. This way attains more accurate detection of an unsafety state than a way without narrowing down of a working area.

Besides, the unsafety level determination part (output part) 16 outputs, per predetermined period, a result of determination thereof from the communication device 8 to the outside. An output destination of the result of the determination includes the cockpit 71 and an unillustrated server. The server is, for example, a management server that manages a whole of a construction site. Examples of the predetermined period include one day and one week. The result of the determination includes an occurrence frequency and a kind of an unsafety level. Use of the result of the determination leads to a satisfactory countermeasure like a strict safety countermeasure on a worksite.

### Operation of the Worksite Monitoring System

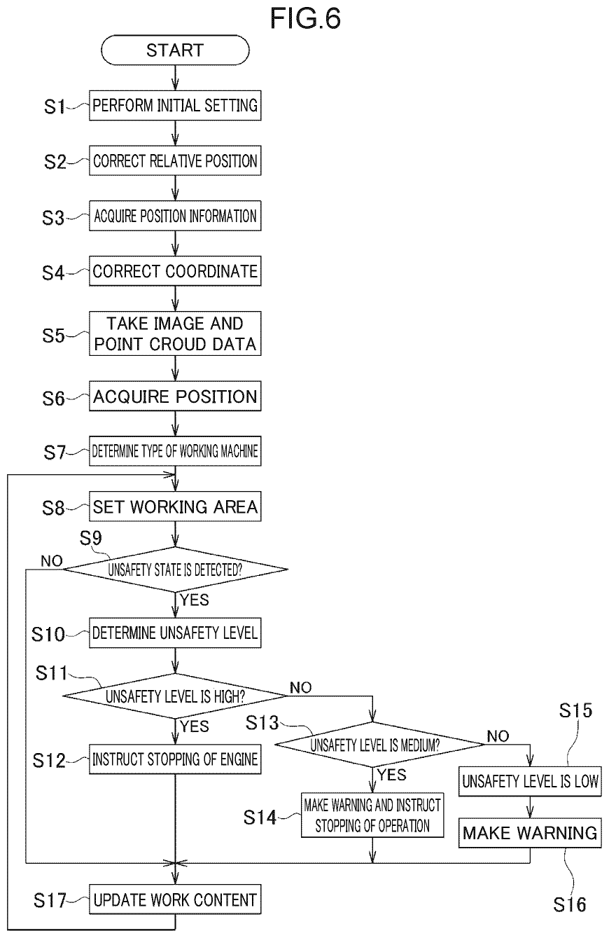

Next, an operation of the worksite monitoring system 1 will be described with reference to FIG. 6 that is a flowchart of a monitoring control process.

First, the controller 5 of the worksite monitoring system 1 performs an initial setting (step S1). Specifically, the camera 2 is subjected to camera calibration. The camera calibration includes determination or correction of: an attachment position of the camera 2; an attachment angle of the camera 2; distortion of a lens of the camera; and a focal distance of the lens of the camera 2. The controller 5 performs calibration between the camera 2 and the LiDAR sensor 3. This calibration indicates a process of associating a coordinate on an image captured by the camera 2 with a coordinate on point cloud data acquired by the LiDAR sensor 3.

Next, the controller 5 corrects a relative position (step S2). Specifically, the point cloud data acquired by the LiDAR sensor 3 is projected onto the image captured by the camera 2 to correct the relative position.

Subsequently, the controller 5 acquires position information (step S3). Specifically, a positioning sensor or other sensor acquires a position of each of the camera 2 and the LiDAR sensor 3 in the global coordinate system.

Then, the controller 5 corrects the three-dimensional coordinate of each of the camera 2 and the LiDAR sensor 3 (step S4).

Next, the controller 5 takes the image captured by the camera 2 and the point cloud data acquired by the LiDAR sensor 3 (step S5). The object detection part 11 of the controller 5 is configured to detect, on the basis of the image captured by the camera 2, a person and a working machine 20 in a worksite. The position acquisition part 12 of the controller 5 acquires a position of each of the person and the working machine 20 detected by the object detection part 11 (step S6).

Subsequently, the type determination part 13 of the controller 5 determines a type of the working machine 20 detected by the object detection part 11 (step S7). The working area setting part 14 of the controller 5 sets a working area for each of working machines 20 detected by the object detection part 11 (step S8).

Subsequently, the unsafety state detection part 15 of the controller 5 determines whether an unsafety state is detected (step S9). In step S9, when it is determined that the unsafety state is not detected (NO in step S9), the controller 5 leads the process to step S17. By contrast, in step S9, when it is determined that the unsafety state is detected (YES in step S9), the unsafety level determination part 16 of the controller 5 determines an unsafety level (step S10).

Then, the countermeasure control part 17 of the controller 5 determines whether the unsafety level is “high” (step S11). In step S11, when the unsafety level is “high” (YES in step S11), the countermeasure control part 17 transmits an instruction of stopping an engine to an associated working machine 20 (step S12). The working machine 20 having received the instruction of stopping the engine stops the engine. The process proceeds to step S17.

By contrast, in step S11, when the unsafety level is not “high” (NO in step S11), the countermeasure control part 17 determines whether the unsafety level is “medium” (step S13). In step S13, when the unsafety level is “medium” (YES in step S13), the countermeasure control part 17 causes a warning device to emit warning and transmits an instruction of stopping a work to the associated working machine 20 (step S14). The working machine 20 having received the instruction of stopping the work temporarily stops an operation of each of the attachment 30 and the slewing device 25. The process proceeds to step S17.

By contrast, in step S13, when the unsafety level is not “medium” (NO in step S13), the countermeasure control part 17 determines whether the unsafety level is “low” (step S15). Then, the countermeasure control part 17 causes the warning device to emit warning (step S16). The process proceeds to step S17.

In step 17, the controller 5 updates the work content stored in the storage device 6 (step S17). Consequently, the working area setting part 14 sets a work content in step S8 for each of the operator driving working machine 20A and the remotely driving working machine 20B again. The process returns to step S8.

The embodiment aims at acquiring a three-dimensional position of an object (a working machine 20 or a person) in a worksite to detect an unsafety state from a relation between the position and the working area. However, a two-dimensional position of the object (the working machine 20 or the person) in the worksite may be acquired to detect an unsafety state from the relation between the position and the working area.

As described heretofore, for a working machine 20 in a worksite, the worksite monitoring system 1 according to the embodiment sets a working area associated with a type of the working machine 20. An unsafety state is detected on the basis of a position of the working machine 20 in the worksite and on the basis of the working area. For a plurality of types of working machines 20, a working area associated with each of the types of the working machines 20 is set. The setting enables more accurate detection of an unsafety state than a setting of a uniform working area for each of the types of the working machines 20. This may keep a state detected as an unsafety state in the setting of the uniform working area for each of the types of the working machines 20 from being detected as such an unsafety state. This consequently eliminates unnecessary execution of a countermeasure, such as notification or stopping of a working machine 20, and thus achieves suppression of a decrease in the work efficiency of the working machine 20.

In the embodiment, an unsafety state is detected further on the basis of a position of a person in the worksite and on the basis of the working area. Here, for a plurality of types of working machines 20, a working area associated with each of the types of the working machines 20 is set. The setting enables more accurate detection of an unsafety state than a setting of a uniform working area for each of the types of the working machines 20. This may keep a state detected as an unsafety state in the setting of the uniform working area for each of the types of the working machines 20 from being detected as such an unsafety state. This consequently eliminates unnecessary execution of a countermeasure, such as notification or stopping of a working machine 20, and thus achieves suppression of a decrease in the work efficiency of the working machine 20.

Besides, a state where a person is in a working area for a working machine 20 is detected as an unsafety state. In this case, execution of a countermeasure of notification or stopping of the working machine 20 may result in avoiding a collision between the person and the working machine 20 in advance.

Moreover, a state where another working machine 20 is in a working area for a certain working machine 20 is detected as an unsafety state. In this case, execution of a countermeasure of notification or stopping of the working machine 20 may result in avoiding a collision between working machines 20 in advance.

A state where a machine body of the working machine 20 is beyond the working area therefor is detected as an unsafety state. In this case, execution of a countermeasure of notification or stopping of the working machine 20 may result in avoiding a collision between a person and the working machine 20, and a collision between working machines 20 in advance.

At least one of warning and stopping of the working machine 20 is executed in accordance with an unsafety level. For instance, warning may lead to avoidance of a collision between working machines 20 at an unsafety level indicative of being irrelevant to an occurrence of a human damage, e.g., a collision between the remotely driving working machine 20B and the autonomous driving working machine 20C. For instance, stopping of the working machine 20 may lead to avoidance of a collision between a working machine 20 and a person at an unsafety level indicative of being relevant to an occurrence of a human damage, e.g., a collision between the working machine 20 and the person.

The embodiment further includes setting a working area for the autonomous driving working machine 20C on the basis of teaching information, i.e., working plan information about autonomous driving. A work content of the autonomous driving working machine 20C is defined with the teaching information. A setting of the working area based on the teaching information enables more accurate detection of an unsafety state.

The embodiment further includes setting the working area for the autonomous driving working machine 20C on the basis of determination as to whether an operator is on the working machine. For instance, in a case where the operator is on the autonomous driving working machine 20C for teaching, a working area is set to be larger than the working area in a case where the operator is not on the autonomous driving working machine 20C in consideration of the manipulation flexibility for the operator. The setting enables more accurate detection of an unsafety state than a setting of a uniform working area that is made regardless of existence or absence of an operator on the machine.

The working area for each of the operator driving working machine 20A and the remotely driving working machine 20B is set on the basis of the work content stored in the storage device 6. The operator driving working machine 20A and the remotely driving working machine 20B often repeat their respective works. The storage device 6 stores relevant work contents of the works for use in setting a working area, and such setting leads to narrowing down the working area. This way attains more accurate detection of an unsafety state than a way without narrowing down of a working area.

Besides, in the embodiment, types of working machines 20 include at least two working machines among the operator manipulating working machine 20A, the remotely driving working machine 20B, and the autonomous driving working machine 20C. In the embodiment, even working machines 20 having the same specification, i.e., the same size and the same shape, are allotted different working areas when the working machines differ in types (20A, 20B, 20C). The setting attains a more suitable working area for an operation state (a type in the present invention) than the setting of a uniform working area in accordance with an outline of a working machine 20. This consequently prevents a setting of an excessively large working area and frequent contact between working areas, and results in suppressing a decrease in the work efficiency of the working machine attributed to frequent notification or frequent stopping of the working machine corresponding to an unsafety state. Relying on an operator for judgment on safety in the manipulative driving of the working machine 20A may succeed in setting a relatively larger working area than a working area in autonomous driving of the machine.

Furthermore, a result of determination from the unsafety level determination part 16 is output per predetermined period. Use of the result of the determination leads to a satisfactory countermeasure like a strict safety countermeasure on a worksite.

Conclusively, the embodiment of the present invention is described heretofore, but is merely described as an example without particularly limiting the present invention. It is the matter of design choice for changes in the details of the configuration. Furthermore, the operations and effects described in the embodiment of the present invention are merely listed as optimal operations and effects attained by the present invention, and thus should not be limited thereto.

The present invention provides a worksite monitoring system. The worksite monitoring system includes: an image capturing part that captures an image of a worksite; an object detection part that is configured to detect, on the basis of the image captured by the image capturing part, a working machine in the worksite; a position acquisition part that acquires a position of the working machine detected by the object detection part; a type determination part that determines a type of the working machine detected by the object detection part; a working area setting part that sets a working area associated with the type determined by the type determination part for the working machine detected by the object detection part; and an unsafety state detection part that detects an unsafety state on the basis of the position of the working machine acquired by the position acquisition part and the working area set by the working area setting part.

In the configuration, the object detection part may be further configured to detect a person in the worksite, the position acquisition part may acquire a position of the person detected by the object detection part, and the unsafety state detection part may detect an unsafety state on the basis of the position of the person acquired by the position acquisition part and the working area set by the working area setting part.

In the configuration, the unsafety state may include a state where the person is in the working area.

In the configuration, the unsafety state may include a state where a working machine is in the working area.

In the configuration, the unsafety state may include a state where a machine body of the working machine is beyond the working area therefor.

The configuration may further include: an unsafety level determination part that determines, on the basis of the unsafety state, an unsafety level; and a control part that performs at least one of warning and stopping of the working machine in accordance with the unsafety level.

In the configuration, types of working machines may include an autonomous driving working machine, and the working area setting part may set a working area for the autonomous driving working machine on the basis of working plan information about autonomous driving.

The configuration may further include: a determination part that determines whether an operator is on the autonomous driving working machine. The working area setting part may set the working area for the autonomous driving working machine on the basis of a result of the determination by the determination part.

In the configuration, types of working machines may include an operator driving working machine and a remotely driving working machine. This configuration may further include a storage device that stores a work content of each of the operator driving working machine and the remotely driving working machine. The working area setting part may set a working area for each of the operator driving working machine and the remotely driving working machine on the basis of the work content stored in the storage device.

In the configuration, types of working machines may include at least two working machines among an operator manipulating working machine, a remotely driving working machine, and an autonomous driving working machine.

The configuration may further include: an unsafety level determination part that determines, on the basis of the unsafety state, an unsafety level; and an output part that outputs, per predetermined period, a result of the determination by the unsafety level determination part.

The present invention includes: setting a working area for a working machine in a worksite in association with a type of the working machine; and detecting an unsafety state on the basis of a position of the working machine in the worksite and on the basis of the working area. For a plurality of types of working machines, a working area associated with each of the types of the working machines is set. The setting enables more accurate detection of an unsafety state than a setting of a uniform working area for each of the types of the working machines. This may keep a state detected as an unsafety state in the setting of the uniform working area for each of the types of the working machines from being detected as such an unsafety state. This consequently eliminates unnecessary execution of a countermeasure, such as notification or stopping of a working machine, and thus achieves suppression of a decrease in the work efficiency of the working machine.

1. A worksite monitoring system, comprising:
an image capturing part that captures an image of a worksite;
an object detection part that is configured to detect, on the basis of the image captured by the image capturing part, a working machine in the worksite;
a position acquisition part that acquires a position of the working machine detected by the object detection part;
a type determination part that determines a type of the working machine detected by the object detection part;
a working area setting part that sets a working area associated with the type determined by the type determination part for the working machine detected by the object detection part; and
an unsafety state detection part that detects an unsafety state on the basis of the position of the working machine acquired by the position acquisition part and the working area set by the working area setting part.

2. The worksite monitoring system according to claim 1, wherein the object detection part is further configured to detect a person in the worksite,
the position acquisition part acquires a position of the person detected by the object detection part, and
the unsafety state detection part detects an unsafety state on the basis of the position of the person acquired by the position acquisition part and the working area set by the working area setting part.

3. The worksite monitoring system according to claim 2, wherein the unsafety state includes a state where the person is in the working area.

4. The worksite monitoring system according to claim 1, wherein the unsafety state includes a state where a working machine is in the working area.

5. The worksite monitoring system according to claim 1, wherein the unsafety state includes a state where a machine body of the working machine is beyond the working area therefor.

6. The worksite monitoring system according to claim 1, further comprising:
an unsafety level determination part that determines, on the basis of the unsafety state, an unsafety level; and
a control part that performs at least one of warning and stopping of the working machine in accordance with the unsafety level.

7. The worksite monitoring system according to claim 1, wherein types of working machines include an autonomous driving working machine, and
the working area setting part sets a working area for the autonomous driving working machine on the basis of working plan information about autonomous driving.

8. The worksite monitoring system according to claim 7, further comprising a determination part that determines whether an operator is on the autonomous driving working machine, wherein
the working area setting part sets the working area for the autonomous driving working machine on the basis of a result of the determination by the determination part.

9. The worksite monitoring system according to claim 1, wherein types of working machines include an operator driving working machine and a remotely driving working machine, the worksite monitoring system further comprising:
a storage device that stores a work content of each of the operator driving working machine and the remotely driving working machine, wherein
the working area setting part sets a working area for each of the operator driving working machine and the remotely driving working machine on the basis of the work content stored in the storage device.

10. The worksite monitoring system according to claim 1, wherein types of working machines include at least two working machines among an operator manipulating working machine, a remotely driving working machine, and an autonomous driving working machine.

11. The worksite monitoring system according to claim 1, further comprising:
an unsafety level determination part that determines, on the basis of the unsafety state, an unsafety level; and
an output part that outputs, per predetermined period, a result of the determination by the unsafety level determination part.
